(19) United States
(12) Patent Application Publication
(10) Pub. No.: US 2026/0011714 A1
(43) Pub. Date: Jan. 8, 2026

(54) LITHIUM ALUMINUM TITANIUM PHOSPHATE (LATP)-CONTAINING POSITIVE ELECTRODES AND BATTERIES INCLUDING THE SAME

(71) Applicant: GM GLOBAL TECHNOLOGY OPERATIONS LLC, Detroit, MI (US)

(72) Inventors: Raneen TAHA, Sterling Heights, MI (US); Vamakshi YADAV, Sterling Heights, MI (US); Zhongyi LIU, Troy, MI (US); Ratandeep Singh KUKREJA, Auburn Hills, MI (US)

(21) Appl. No.: 18/762,033

(22) Filed: Jul. 2, 2024

(51) Int. Cl. H01M 4/36; H01M 4/02; H01M 4/04; H01M 4/131; H01M 4/136; H01M 4/1391; H01M 4/1397; H01M 4/505; H01M 4/58; H01M 4/62; H01M 10/0525

(52) U.S. Cl. CPC H01M 4/364; H01M 4/0404; H01M 4/0471; H01M 4/131; H01M 4/136; H01M 4/1391; H01M 4/1397; H01M 4/505; H01M 4/5825; H01M 4/622; H01M 10/0525; H01M 2004/021; H01M 2004/028

(57) ABSTRACT

A positive electrode for a battery that cycles lithium ions includes a physical mixture of electroactive material particles and lithium aluminum titanium phosphate (LATP) particles. The electroactive material particles include a lithium-rich and manganese-based oxide. The electroactive material particles have a first mean particle diameter (D1), the LATP particles have a second mean particle diameter (D2), and a ratio of the first mean particle diameter to the second mean particle diameter (D1:D2) is greater than or equal to 4:1 and less than or equal to 1000:1.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to positive electrodes for batteries that cycle lithium ions and, more particularly, to particulate additives for positive electrodes including lithium-rich and manganese-based oxides as electroactive positive electrode materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrodes may be composite materials and may include a mixture of electrochemically active (electroactive) material particles, a polymer binder, and optionally an electrically conductive material. Additives may be included in the batteries to help prevent undesirable chemical reactions from occurring between the electroactive material particles in the electrodes and the electrolyte during cycling of the batteries. For example, such additives may help promote the formation of robust solid electrolyte interphase layers on surfaces of the electroactive material particles of the electrodes.

### SUMMARY

A positive electrode, in accordance with one or more embodiments of the present disclosure, comprises a physical mixture of electroactive material particles and lithium aluminum titanium phosphate (LATP) particles. The electroactive material particles comprise a lithium-rich and manganese-based oxide. The electroactive material particles have a first mean particle diameter (D1), the LATP particles have a second mean particle diameter (D2), and a ratio of the first mean particle diameter to the second mean particle diameter (D1:D2) is greater than or equal to 4:1 and less than or equal to 1000:1.

The LATP particles may comprise lithium aluminum titanium phosphate having the formula Li₁₋ₓAlₓTi₂₋ₓ(PO₄)₃, where 0.1≤x≤0.6.

The LATP particles may be present in the positive electrode in an amount constituting, by weight, greater than or equal to 0.5% and less than or equal to 4%, based on the total weight of the electroactive material particles in the positive electrode.

The LATP particles may be substantially amorphous.

The LATP particles may be discrete from the electroactive material particles. The LATP particles may not be physically or chemically bonded to the electroactive material particles.

A ratio of the first mean particle diameter to the second mean particle diameter (D1:D2) may be greater than or equal to 18:1 and less than or equal to 200:1.

The second mean particle diameter of the LATP particles may be greater than or equal to 10 nanometers and less than or equal to 2 micrometers.

The first mean particle diameter of the electroactive material particles may be greater than or equal to 8 micrometers and less than or equal to 12 micrometers.

The electroactive material particles may comprise a layered lithium-rich and manganese-based transition metal oxide represented by the formula Li₁₊ₓMe₁₋ₓO₂, where 0<x≤0.33, Me comprises at least one transition metal, and Me comprises, on an atomic basis, greater than 50% manganese (Mn).

The electroactive material particles may constitute, by weight, greater than or equal to 90% of the positive electrode.

The positive electrode may further comprise a polymer binder and optionally an electrically conductive material.

A battery that cycles lithium ions, in accordance with one or more embodiments of the present disclosure, comprises a negative electrode and a positive electrode spaced apart from the negative electrode. The negative electrode comprises an electroactive negative electrode material. The positive electrode comprises a physical mixture of electroactive material particles and lithium aluminum titanium phosphate (LATP) particles. The electroactive material particles comprise a lithium-rich and manganese-based oxide. The electroactive material particles have a first mean particle diameter (D1), the LATP particles have a second mean particle diameter (D2), and a ratio of the first mean particle diameter to the second mean particle diameter (D1:D2) is greater than or equal to 18:1 and less than or equal to 200:1.

The LATP particles may comprise lithium aluminum titanium phosphate having the formula Li₁₋ₓAlₓTi₂₋ₓ(PO₄)₃, where 0.1≤x≤0.6.

The electroactive material particles may constitute, by weight, greater than or equal to 90% of the positive electrode.

The LATP particles may be present in the positive electrode in an amount constituting, by weight, greater than or equal to 0.5% and less than or equal to 4%, based on the total weight of the electroactive material particles in the positive electrode.

The second mean particle diameter of the LATP particles may be greater than or equal to 50 nanometers and less than or equal to 0.5 micrometers, and the first mean particle diameter of the electroactive material particles may be greater than or equal to 9 micrometers and less than or equal to 10 micrometers.

The electroactive material particles may comprise a layered lithium-rich and manganese-based transition metal oxide represented by the formula Li₁₊ₓMe₁₋ₓO₂, where 0<x≤0.33, Me comprises at least one transition metal, and Me comprises, on an atomic basis, greater than 50% manganese (Mn).

After initial and/or repeated cycling of the battery, the positive electrode may further comprise lithium phosphate and/or lithium titanium phosphate oxide.

In a method of manufacturing a positive electrode for a battery that cycles lithium ions, in accordance with one or more embodiments of the present disclosure, a solid mixture comprising electroactive material particles and lithium aluminum titanium phosphate (LATP) particles is prepared. The electroactive material particles comprise a lithium-rich and manganese-based oxide. In the solid mixture, the electroactive material particles have a first mean particle diameter (D1), the LATP particles have a second mean particle diameter (D2) less than the first mean particle diameter, and a ratio of the first mean particle diameter to the second mean particle diameter (D1:D2) is greater than or equal to 4:1 and less than or equal to 1000:1. The solid mixture is heated at elevated temperature to form a calcined mixture comprising the electroactive material particles and the LATP particles. An electrode precursor mixture is prepared comprising the calcined mixture, a polymer binder, and a solvent. The electrode precursor mixture is deposited on a substrate to form an electrode precursor layer. Then, the solvent is removed from the electrode precursor layer to form the positive electrode.

The solid mixture may be heated at an elevated temperature of greater than or equal to 450 degrees Celsius and less than or equal to 650 degrees Celsius to form the calcined mixture.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

In the drawings, reference numbers may be reused to identify similar and/or identical elements.

### DETAILED DESCRIPTION

The presently disclosed positive electrodes comprise a physical mixture of positive electrode electroactive material particles and lithium aluminum titanium phosphate (LATP) particles and can be used in batteries that cycle lithium ions to help improve the cycling stability thereof.

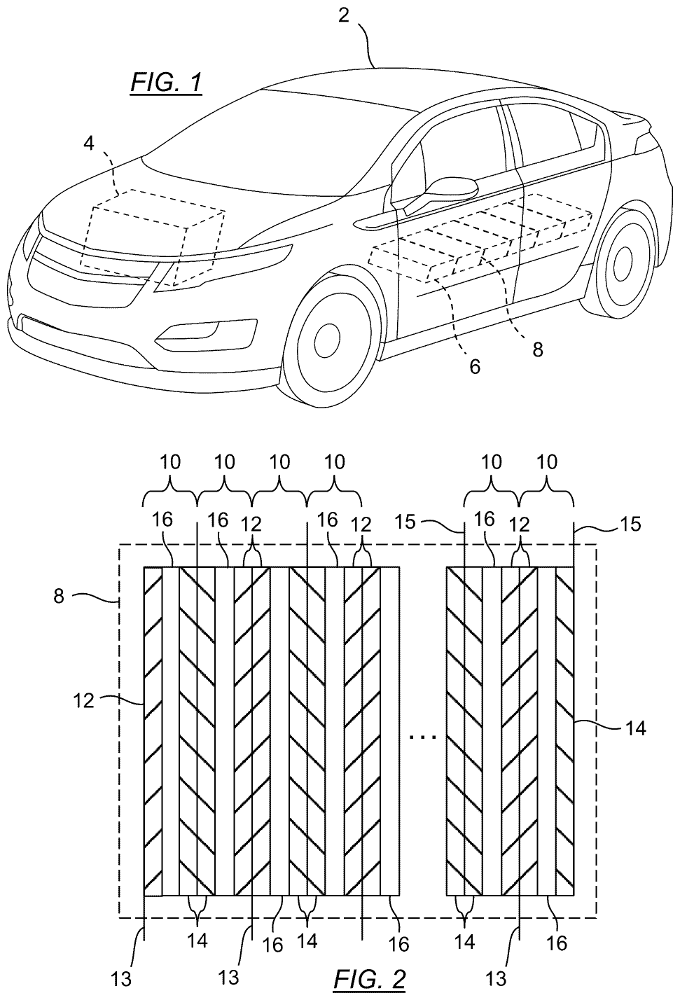

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

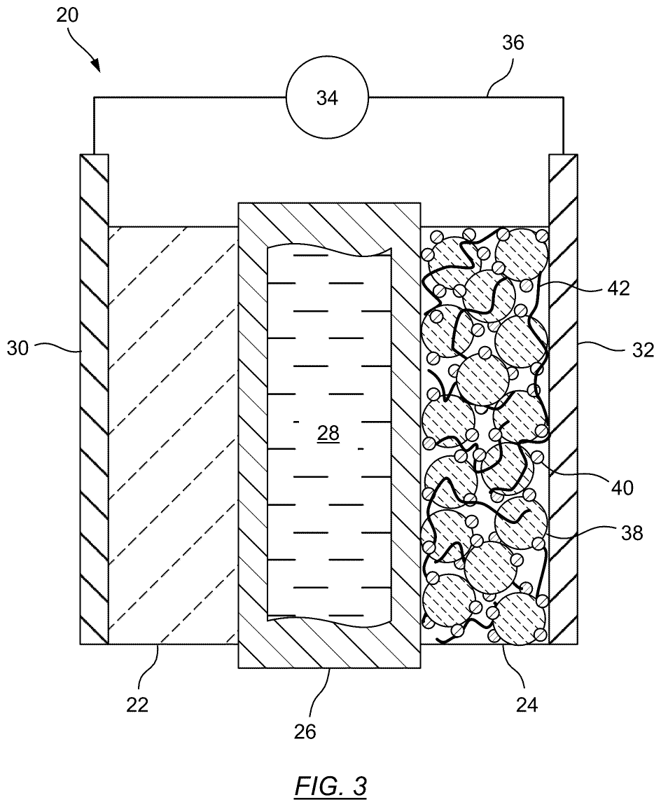

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 is formulated to store and release lithium ions during discharge and charge of the battery 20. The positive electrode 24 is in the form of a continuous porous layer and may be disposed on the major surface of the positive electrode current collector 32. As shown in FIG. 3, the positive electrode 24 comprises electroactive material particles 38, lithium aluminum titanium phosphate (LATP) particles 40, a polymer binder 42, and optionally an electrically conductive material (not shown). The electroactive material particles 38, the LATP particles 40, the polymer binder 42, and the optional electrically conductive material may be distributed substantially homogenously throughout the positive electrode 24. In aspects, the positive electrode 24 may have a porosity of greater than or equal to 10%, or optionally greater than or equal to 20%, and less than or equal to 40%, or optionally less than or equal to 30%.

The electroactive material particles 38 may constitute, by weight, greater than or equal to 50%, optionally greater than or equal to 60%, optionally greater than or equal to 70%, optionally greater than or equal to 90%, or optionally greater than or equal to 95%, and less than or equal to 98% of the positive electrode 24. The electroactive material particles 38 may have a mean particle diameter of greater than or equal to 8 micrometers (μm), or optionally greater than or equal to 9 micrometers, and less than or equal to 12 micrometers, or optionally less than or equal to 10 micrometers. In aspects, the electroactive material particles 38 may have a substantially equiaxed structure and may have aspect ratios of greater than or equal to 1 and less than or equal to 2, optionally less than or equal to 1.5, or optionally less than or equal to 1.2.

The electroactive material particles 38 of the positive electrode 24 comprise an electroactive material (an electroactive positive electrode material) that is formulated to store and release lithium ions by undergoing a reversible redox reaction with lithium at a higher electrochemical potential than the electroactive material of the negative electrode 22 such that an electrochemical potential difference exists between the negative electrode 22 and the positive electrode 24. The electroactive material particles 38 may comprise a material that can undergo lithium intercalation and deintercalation or a material that can undergo a conversion reaction with lithium. In aspects where the electroactive material particles 38 comprise an intercalation host material that can undergo the reversible insertion or intercalation of lithium ions, the electroactive material particles 38 may comprise a lithium transition metal oxide. For example, the electroactive material particles 38 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof).

In embodiments, the electroactive material particles 38 may comprise a “high-voltage” electroactive material and may have an upper cutoff potential of greater than or equal to 4.3 V, optionally greater than or equal to 4.4 V, optionally greater than or equal to 4.6 V, or optionally greater than or equal to 4.8 V, and less than or equal to 5 V versus Li⁺/Li. In aspects, the electroactive material particles 38 may comprise may comprise a layered lithium-rich and manganese-based transition metal oxide represented by the formula Li₁₊ₓMe₁₋ₓO₂, where 0<x≤0.33 and where Me comprises, on an atomic basis, greater than or equal to about 50% manganese (Mn), or optionally greater than or equal to 60% Mn, and less than or equal to 100% Mn, or optionally less than or equal to 70% Mn. In embodiments, Me may comprise Mn, Ni, and Co. In other embodiments, Me may comprise Mn and Ni. Such layered lithium-rich and manganese-based transition metal oxides may have an upper cutoff potential of at least 4.6 V versus Li⁺/Li.

The LATP particles 40 are configured to provide a protective interface between the electroactive material particles 38 and the electrolyte 28 infiltrating the positive electrode 24 that helps prevent and/or inhibit undesirable chemical reactions from occurring between the electroactive material particles 38 and the electrolyte 28 during cycling of the battery 20, without inhibiting the transfer of lithium ions between the electroactive material particles 38 and the electrolyte 28.

The LATP particles 40 are formulated to be electrochemically inactive, electrically insulating, ionically conductive, and to be chemically compatible with the other components of the positive electrode 24. The LATP particles 40 may comprise lithium aluminum titanium phosphate having the formula Li₁₋ₓAlₓTi₂₋ₓ(PO₄)₃, where x is greater than or equal to 0.1, optionally greater than or equal to 0.2, or optionally greater than or equal to 0.3, and less than or equal to 0.6, or optionally less than or equal to 0.5. In aspects, the LATP particles 40 may comprise lithium aluminum titanium phosphate having the formula Li₁₋ₓAlₓTi₂₋ₓ(PO₄)₃, where x is about 0.4. In aspects, during initial and/or repeated cycling of the battery 20, the LATP particles 40 may decompose and form electrically insulating and ionically conductive Li, Ti, P, and/or O-containing compounds, such as lithium phosphate (Li₃PO₄) and/or lithium titanium phosphate oxide (e.g., LiTiPO₅), which may assist in formation of a protective interface between the electroactive material particles 38 and the electrolyte 28.

The mean particle diameter of the LATP particles 40 and the amount of the LATP particles 40 included in the positive electrode 24 may be selected based on the mean particle diameter and the amount of the electroactive material particles 38 included in the positive electrode 24. For example, the electroactive material particles 38 may have a first mean particle diameter (D1) and the LATP particles 40 may have a second mean particle diameter (D2) that is less than the first mean particle diameter (D1) of the electroactive material particles 38. In aspects, a ratio of the first mean particle diameter to the second mean particle diameter (D1:D2) may be greater than or equal to 4:1, or optionally greater than or equal to 18:1, and less than or equal to 1000:1, or optionally less than or equal to 200:1. In aspects, the LATP particles 40 may have a mean particle diameter of greater than or equal to 10 nanometers (nm), or optionally greater than or 50 nanometers, and less than or equal to 2 micrometers, or optionally less than or equal to 0.5 micrometers. In aspects, the LATP particles 40 may be included in the positive electrode 24 in an amount constituting, by weight, greater than or equal to 0.5%, optionally greater than or equal to 1%, or optionally greater than or equal to 1.5%, and less than or equal to 4%, optionally less than or equal to 3%, optionally less than or equal to 2.5%, or optionally less than or equal to 2%, based on the total weight of the electroactive material particles 38 in the positive electrode 24. In aspects, this may mean that the LATP particles 40 constitute, by weight, greater than or equal to 0.55%, optionally greater than or equal to 1%, or optionally greater than or equal to 1.5%, and less than or equal to 3.8%, optionally less than or equal to 3%, optionally less than or equal to 2.5%, or optionally less than or equal to 2%, of the positive electrode 24.

The LATP particles 40 may have a substantially equiaxed structure and may have aspect ratios of greater than or equal to 1 and less than or equal to 2, optionally less than or equal to 1.5, or optionally less than or equal to 1.2. The LATP particles 40 are substantially amorphous (non-crystalline), meaning that the LATP particles 40 may be less than or equal to 1% crystalline, optionally less than or equal to 0.1% crystalline, or optionally 0% crystalline.

The electroactive material particles 38 and the LATP particles 40 are present in the positive electrode 24 as a physical mixture of discrete particles, meaning that the LATP particles 40 are not physically or chemically bonded to the electroactive material particles 38 in the positive electrode 24. In addition, the LATP particles 40 are not present as a conformal and/or continuous coating on surfaces of the electroactive material particles 38 in the positive electrode 24. Without intending to be bound by theory, it is believed that the composition of the LATP particles 40 and the relatively small mean particle diameter of the LATP particles 40, as compared to that of the electroactive material particles 38, allows the LATP particles 40 form a robust yet discontinuous network around the electroactive material particles 38. In addition, it is believed that the composition of the LATP particles 40 and the relatively small mean particle diameter of the LATP particles 40, as compared to that of the electroactive material particles 38, allows the LATP particles 40 form an interface between the electroactive material particles 38 and the electrolyte 28 that effectively inhibits undesirable chemical reactions from occurring between the electroactive material particles 38 and the electrolyte 28 during cycling of the battery 20, without inhibiting the transfer of lithium ions between electroactive material particles 38 and the electrolyte 28 and without inhibiting the movement of lithium ions through the positive electrode 24.

The polymer binder 42 is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder 42 may constitute, by weight, greater than or equal to 1%, or optionally greater than or equal to 2%, and less than or equal to 10%, or optionally less than or equal to 5%, of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to 1%, and less than or equal to 10%, or optionally less than or equal to 5%, of the positive electrode 24.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises an electroactive material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 97%, optionally less than or equal to about 90%, or optionally less than or equal to about 80% of the negative electrode 22.

In embodiments, the electroactive material of the negative electrode 22 may comprise a silicon oxide-based material (e.g., Si, SiOₓ, and/or Li_{y}SiOₓ) and a carbon-based material (e.g., graphite). In such case, the silicon oxide-based material may constitute, by weight, greater than or equal to 10% and less than or equal to 70%, or optionally less than or equal to 30%, of the electroactive material of the negative electrode 22 and the carbon-based material (e.g., graphite) may constitute, by weight, greater than or equal to 30%, or optionally greater than or equal to 70%, and less than or equal to 90% of the electroactive material of the negative electrode 22.

In embodiments, the negative electrode 22 may be porous and the electroactive material of the negative electrode 22 may be a particulate material. In embodiments where the electroactive material of the negative electrode 22 is a particulate material, particles of the electroactive material of the negative electrode 22 may be intermingled with a polymer binder and optionally an electrically conductive material. The same polymer binders and/or electrically conductive materials disclosed above with respect to the positive electrode 24 may be used in the negative electrode 22 in substantially the same amounts. In other embodiments, the electroactive material of the negative electrode 22 may consist of lithium and the negative electrode 22 may be in the form of a nonporous metal film or foil, such as a lithium metal film or lithium metal foil. In such case, the negative electrode 22 may comprise, by weight, greater than 97% lithium, or optionally greater than 99% lithium. In embodiments where the electroactive material of the negative electrode 22 consists of lithium, the negative electrode 22 may be substantially free of elements or compounds that undergo a reversible redox reaction with lithium during operation of the battery 20. In addition, in embodiments where the electroactive material of the negative electrode 22 consists of lithium, the negative electrode 22 may be substantially free of a polymer binder.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene) (PTFE), polyvinylidene fluoride (PVDF), poly(vinyl chloride) (PVC), and combinations thereof. In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂). The separator 26 may have a thickness of greater than or equal to about 5 micrometers (μm), optionally greater than or equal to about 10 μm, or optionally greater than or equal to about 20 μm and less than or equal to about 500 μm, optionally less than or equal to about 200 μm, or optionally less than or equal to about 50 μm.

The electrolyte 28 is ionically conductive and provides a medium for the conduction of lithium ions between the negative electrode 22 and the positive electrode 24. The electrolyte 28 comprises an organic solvent and a lithium salt in the organic solvent.

The organic solvent may comprise a nonaqueous aprotic organic solvent. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. In aspects, the organic solvent may comprise a mixture of a cyclic carbonate and a linear carbonate. The organic solvent may constitute, by weight, greater than or equal to 80%, or optionally greater than or equal to 85%, and less than or equal to 95%, or optionally less than or equal to 90% of the electrolyte 28.

The lithium salt is soluble in the organic solvent and provides a passage for lithium ions through the electrolyte 28. The lithium salt may comprise an inorganic lithium salt, an organic lithium salt, or a combination thereof. Examples of lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethanesulfonyl)imide (LiN(CF₃SO₂)₂) (LiTFSI), lithium bis(fluorosulfonyl)imide (LiN(FSO₂)₂) (LiFSI), lithium tetraphenylborate (LiB(C₆H₅)₄), lithium bis(oxalato)borate (LiB(C₂O₄)₂) (LiBOB), lithium difluoro(oxalato)borate (LiBF₂(C₂O₄)) (LiDFOB), and combinations thereof. In aspects, the lithium salt may comprise LiPF₆. The lithium salt may be dissolved in the organic solvent at a concentration of greater than or equal to 0.5 Molar and less than or equal to 1.5 Molar. In aspects, the lithium salt may be dissolved in the organic solvent at a concentration of about 1 Molar. The lithium salt may constitute, by weight, greater than or equal to 5%, optionally greater than or equal to 10%, and less than or equal to 20%, or optionally less than or equal to 15% of the electrolyte 28.

The negative electrode current collector 30 and the positive electrode current collector 32 are electrochemically inactive and electrically conductive and provide an electrical connection between the external circuit 36 and the negative electrode 22 and the positive electrode 24, respectively. In aspects, the negative electrode current collector 30 and the positive electrode current collector 32 may be in the form of nonporous metal foils, perforated metal foils, porous metal meshes, or a combination thereof. The negative electrode current collector 30 and the positive electrode current collector 32 may be made of metal or other appropriate electrically conductive material (e.g., carbon). In aspects where the negative electrode current collector 30 and/or the positive electrode current collector 32 are made of metal, the metal may be a substantially pure elemental metal or an alloy of an elemental metal and one or more other metal or nonmetal elements (referred to as “alloying” elements). In aspects, the negative electrode current collector 30 may be made of copper, nickel, or stainless steel, and the positive electrode current collector 32 may be made of aluminum.

### Methods

The positive electrode 24 may be manufactured by forming a solid mixture comprising the electroactive material particles 38 and the LATP particles 40. The solid mixture optionally may be heated at an elevated temperature to form a calcined mixture comprising the electroactive material particles 38 and the LATP particles 40. For example, the solid mixture may be heated at an elevated temperature of greater than or equal to 400 degrees Celsius (° C.), optionally greater than or equal to 450° C., or optionally greater than or equal to 500° C., and less than or equal to 700° C., optionally less than or equal to 650° C., optionally less than or equal to 600° C., or optionally less than or equal to 500° C. to form the calcined mixture. Thereafter, an electrode precursor mixture may be prepared comprising the calcined mixture, the polymer binder 42, the optional electrically conductive material, and a solvent. The electroactive material particles 38, the LATP particles 40, the polymer binder 42, and the optional electrically conductive material may be present in the electrode precursor mixture in substantially the same proportions as in the positive electrode 24. The electrode precursor mixture may be deposited on a substrate to form an electrode precursor layer, and then the solvent may be from the electrode precursor layer to form the positive electrode 24.

Without intending to be bound by theory, it is believed that calcining the solid mixture of the electroactive material particles 38 and the LATP particles 40 prior to forming the positive electrode 24 may help create an intimate association between the electroactive material particles 38 and the LATP particles 40, without forming a chemical and/or physical bond between the electroactive material particles 38 and the LATP particles 40, and that such intimate association may help form a protective interface around the electroactive material particles 38 that helps prevent undesirable chemical reactions from occurring between the electroactive material particles 38 and the electrolyte 28 during cycling of the battery 20, without inhibiting the transfer of lithium ions between the electroactive material particles 38 and the electrolyte 28.

### EXPERIMENTAL

Full coin cells including different positive electrode formulations were assembled and evaluated using galvanostatic charge and discharge protocols. All cells included an electrolyte consisting of: 1.2 Molar LiPF₆ in a mixture of FEC and DEC (FEC:DEC=1:4 vol/vol) with 1% by weight LiPO₂F₂. All cells included a negative electrode consisting of: an electroactive material consisting of a mixture of 5.5 wt % silicon oxide and graphite, electrically conductive particles, and a polymer binder and having 30% porosity and a capacity of 5.5 milliamp hours per square centimeter (mAh/cm²). A baseline positive electrode was prepared comprising: an electroactive material consisting of Li₂MnO₃(LMR) particles, electrically conductive particles, and a polymer binder and having 30% porosity, a capacity of 5 mAh/cm², an active mass loading of 23 milligrams per square centimeter (mg/cm²), and a diameter of about 12.7 millimeters (mm). The LMR particles had a mean particle diameter in a range of 9 μm to 10 μm and were 100% amorphous.

LATP-containing positive electrodes in accordance with embodiments of the present disclosure were prepared by adding to the baseline positive electrode 2% LATP with respect to the total weight of LMR in the positive electrode. The LATP-containing positive electrodes were prepared by forming physical mixtures of LMR particles and LATP particles (LMR-LATP mixtures) by mixing the LMR particles and the LATP particles together at 500 revolutions per minute (rpm) for 5 minutes and then optionally calcining the physical mixtures at 500° C. or 700° C. The as-prepared LMR-LATP mixtures were 100% amorphous. Thereafter, the LMR-LATP mixtures were combined with the electrically conductive particles, the polymer binder, and a solvent and mixed at 500 rpm for 5 minutes to form a slurry. The slurry was deposited on a metal substrate in the form of a thin, continuous, and substantially uniform layer, and then the solvent was removed therefrom by evaporation to form the LATP-containing positive electrodes.

Transmission electron microscope (TEM) images were taken of the calcined LMR-LATP mixtures prior to forming the LATP-containing positive electrodes. The TEM images showed that, even after the LMR-LATP mixtures are calcined, the LATP particles: remained physically discrete from the LMR particles, were not physically or chemically bonded to the LMR particles, and did not form a conformal coating on surfaces of the LMR particles.

X-ray fluorescence (XRF) images were taken of some of the LATP-containing positive electrodes prior to assembling the positive electrodes into coin cells. The XRF images depicted a substantially uniform and homogenous distribution of titanium (Ti) and phosphorus (P) throughout the LATP-containing positive electrodes, which indicates that the LATP particles are substantially homogenously distributed throughout the LATP-containing positive electrodes. In addition, the substantially uniform and homogenous distribution of Ti and P throughout the LATP-containing positive electrodes further indicates that the LATP particles in the as-prepared LATP-containing positive electrodes are present as a loose interface and are not present as a conformal coating on the LMR particles.

Cells including the baseline positive electrode or an LATP-containing positive electrode were galvanostatically charged and discharged at 25° C. During formation, the cells were charged and discharged for two cycles using a constant current and constant voltage (CCCV) protocol, wherein the cells were charged at a constant current and C/20 rate to 4.6 V, then charged at a constant voltage of 4.6 V until the current reached C/50, followed by discharge at a constant current and C/20 rate to 2.0 V. After formation, the cells were charged and discharged using a CCCV protocol, wherein the cells were charged at a constant current and C/3 rate to 4.6 V, then charged at a constant voltage of 4.6 V until the current reached C/20, followed by discharge at a constant current and C/3 rate to 2.0 V.

After formation, cells including the baseline positive electrode and cells including the LATP-containing positive electrodes were galvanostatically charged and discharged at different C-rates; in particular, the cells were cycled at 0.05 C for 2 cycles, 0.33 C for 3 cycles, 0.5 C for 3 cycles, 1 C for 3 cycles, 2 C for 3 cycles, 4 C for 3 cycles, and then 0.33 C for 8 cycles. The results showed that the inclusion of the LATP particles in the positive electrodes did not negatively impact the rate performance of the cells, which further indicates that the LATP particles in the as-prepared LATP-containing positive electrodes are not present as a conformal coating on the LMR particles but instead act as a loose interface that allows for easy Li ion mobility through the LATP-containing positive electrodes.

Cells including the baseline positive electrode had an average specific discharge capacity of about 218.5 milliamp hours per gram (mAh/g) and a discharge capacity retention of about 86.96% after 100 cycles.

Six (6) different LATP-containing positive electrode formulations and their measured specific discharge capacities and discharge capacity retention after 100 cycles are shown in Table 1 below.

TABLE 1

| | LATP | | | Discharge |
|---|---|---|---|---|
| | Mean | Calcina- | Specific | Capacity |
| | Particle | tion | Discharge | Retention, |
| Example Positive | Diameter | Temp. | Capacity | 100 cycles |
| Electrode | (μm) | (° C.) | (mAh/g) | (%) |
| LMR-LATP-1.22 | 1.22 | none | 223.5 | 90.25 |
| LMR-LATP-2.56 | 2.56 | none | 215.8 | 89.25 |
| LMR-LATP-1.22-500 C. | 1.22 | 500 | 205 | 93.51 |
| LMR-LATP-2.56-500 C. | 2.56 | 500 | 223.5 | 91.32 |
| LMR-LATP-1.22-700 C. | 1.22 | 700 | 200.3 | 88.57 |
| LMR-LATP-2.56-700 C. | 2.56 | 700 | 207.9 | 92.06 |

The results of the galvanostatic cycling experiments show that inclusion of the LATP particles in the as-prepared LATP-containing positive electrodes increased the discharge capacity retention, enhanced the cycling stability, and increased the cycle life of the cells including the LATP-containing positive electrodes, as compared to that of the cells including the baseline positive electrode. Without intending to be bound by theory, it is believed that the LATP particles may function as an ionically-conductive additive and the inclusion of the LATP particles in the as-prepared LATP-containing positive electrodes may help promote the formation of a robust, stable CEI, mitigate structural degradation of the LMR particles during cycling, minimize undesired side reactions between the LMR particles and the electrolyte, and reduce lithium loss.

In addition, the results of the galvanostatic cycling experiments show that calcination of the LMR-LATP mixtures prior to formation of the LATP-containing positive electrodes enhances the benefits imparted by addition of the LATP particles and that calcining the LMR-LATP mixtures at temperatures of about 500° C. produced superior results than calcining the LMR-LATP mixtures at 700° C.

Furthermore, the results of the galvanostatic cycling experiments show that the inclusion of LATP particles having a mean particle diameter of either 2.56 μm or 1.22 μm can effectively improve the discharge capacity retention of cells including the LATP-containing positive electrodes, as compared to cells including the baseline positive electrode. When the LATP particles had a relatively small mean particle diameter of 1.22 μm, both the specific discharge capacity and discharge capacity retention of cells including the LATP-containing positive electrodes was improved, as compared to cells including the baseline positive electrode, which is believed to result from the relatively small LATP particle size, which may allow for the formation of a more comprehensive interface between the LATP particles and the LMR particles within the LATP-containing positive electrodes. When the LATP particles had a larger mean particle diameter of 2.56 μm, the discharge capacity retention of cells including the LATP-containing positive electrodes was improved, as compared to cells including the baseline positive electrode, although the initial specific discharge capacity of the cells was lower than that of the cells including the baseline positive electrode and the cells including LATP-containing positive electrodes with LATP particles having a mean particle diameter of 1.22 μm.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a percentage (%) basis. This may include compositions or materials having greater than 50% X, as well as those having less than 50% X, so long as X is the single largest constituent of the composition or material. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A positive electrode comprising:
a physical mixture of:
electroactive material particles comprising a lithium-rich and manganese-based oxide, and
lithium aluminum titanium phosphate (LATP) particles,
wherein the electroactive material particles have a first mean particle diameter (D1), the LATP particles have a second mean particle diameter (D2), and a ratio of the first mean particle diameter to the second mean particle diameter (D1:D2) is greater than or equal to 4:1 and less than or equal to 1000:1.

2. The positive electrode of claim 1, wherein the LATP particles comprise lithium aluminum titanium phosphate having the formula Li₁₋ₓAlₓTi₂₋ₓ(PO₄)₃, where 0.1≤x≤0.6.

3. The positive electrode of claim 2, wherein the LATP particles are present in the positive electrode in an amount constituting, by weight, greater than or equal to 0.5% and less than or equal to 4%, based on the total weight of the electroactive material particles in the positive electrode.

4. The positive electrode of claim 1, wherein the LATP particles are substantially amorphous.

5. The positive electrode of claim 1, wherein the LATP particles are discrete from the electroactive material particles, and wherein the LATP particles are not physically or chemically bonded to the electroactive material particles.

6. The positive electrode of claim 1, wherein a ratio of the first mean particle diameter to the second mean particle diameter (D1:D2) is greater than or equal to 18:1 and less than or equal to 200:1.

7. The positive electrode of claim 1, wherein the second mean particle diameter of the LATP particles is greater than or equal to 10 nanometers and less than or equal to 2 micrometers.

8. The positive electrode of claim 7, wherein the first mean particle diameter of the electroactive material particles is greater than or equal to 8 micrometers and less than or equal to 12 micrometers.

9. The positive electrode of claim 1, wherein the electroactive material particles comprise a layered lithium-rich and manganese-based transition metal oxide represented by the formula Li₁₊ₓMe₁₋ₓO₂, wherein 0<x≤0.33, wherein Me comprises at least one transition metal, and wherein Me comprises, on an atomic basis, greater than 50% manganese (Mn).

10. The positive electrode of claim 9, wherein the electroactive material particles constitute, by weight, greater than or equal to 90% of the positive electrode.

11. The positive electrode of claim 1, further comprising a polymer binder and optionally an electrically conductive material.

12. A battery that cycles lithium ions comprising:
a negative electrode comprising an electroactive negative electrode material;
a positive electrode spaced apart from the negative electrode, the positive electrode comprising a physical mixture of:
electroactive material particles comprising a lithium-rich and manganese-based oxide, and
lithium aluminum titanium phosphate (LATP) particles,
wherein the electroactive material particles have a first mean particle diameter (D1), the LATP particles have a second mean particle diameter (D2), and a ratio of the first mean particle diameter to the second mean particle diameter (D1:D2) is greater than or equal to 18:1 and less than or equal to 200:1.

13. The battery of claim 12, wherein the LATP particles comprise lithium aluminum titanium phosphate having the formula Li₁₋ₓAlₓTi₂₋ₓ(PO₄)₃, where 0.1≤x≤0.6.

14. The battery of claim 12, wherein the electroactive material particles constitute, by weight, greater than or equal to 90% of the positive electrode.

15. The battery of claim 14, wherein the LATP particles are present in the positive electrode in an amount constituting, by weight, greater than or equal to 0.5% and less than or equal to 4%, based on the total weight of the electroactive material particles in the positive electrode.

16. The battery of claim 12, wherein the second mean particle diameter of the LATP particles is greater than or equal to 50 nanometers and less than or equal to 0.5 micrometers, and wherein the first mean particle diameter of the electroactive material particles is greater than or equal to 9 micrometers and less than or equal to 10 micrometers.

17. The battery of claim 12, wherein the electroactive material particles comprise a layered lithium-rich and manganese-based transition metal oxide represented by the formula Li₁₊ₓMe₁₋ₓO₂, wherein 0<x≤0.33, wherein Me comprises at least one transition metal, and wherein Me comprises, on an atomic basis, greater than 50% manganese (Mn).

18. The battery of claim 12, wherein, after initial and/or repeated cycling of the battery, the positive electrode further comprises lithium phosphate and/or lithium titanium phosphate oxide.

19. A method of manufacturing a positive electrode for a battery that cycles lithium ions, the method comprising:
preparing a solid mixture comprising electroactive material particles and lithium aluminum titanium phosphate (LATP) particles, the electroactive material particles comprising a lithium-rich and manganese-based oxide, the electroactive material particles having a first mean particle diameter (D1), the LATP particles having a second mean particle diameter (D2) less than the first mean particle diameter, and wherein a ratio of the first mean particle diameter to the second mean particle diameter (D1:D2) is greater than or equal to 4:1 and less than or equal to 1000:1;
heating the solid mixture at elevated temperature to form a calcined mixture comprising the electroactive material particles and the LATP particles;
preparing an electrode precursor mixture comprising the calcined mixture, a polymer binder, and a solvent;
depositing the electrode precursor mixture on a substrate to form an electrode precursor layer; and then removing the solvent from the electrode precursor layer to form the positive electrode.

20. The method of claim 19, wherein the solid mixture is heated at an elevated temperature of greater than or equal to 450 degrees Celsius and less than or equal to 650 degrees Celsius to form the calcined mixture.
